(19) United States
(12) Patent Application Publication
(10) Pub. No.: US 2014/0045412 A1
(43) Pub. Date: Feb. 13, 2014

(54) SURFACE POLISHING COMPOSITION

(71) Applicant: ILLINOIS TOOL WORKS, INC., Glenview, IL (US)

(72) Inventors: Jordan James Yuska, Plano, TX (US); Mohsen Marzouk, Flower Mound, TX (US)

(73) Assignee: ILLINOIS TOOL WORKS, INC., Glenview, IL (US)

(21) Appl. No.: 13/834,497

(22) Filed: Mar. 15, 2013

Related U.S. Application Data
(60) Provisional application No. 61/681,300, filed on Aug. 9, 2012.

(51) Int. Cl. C11D 7/26; B24B 1/00; B24D 15/00

(52) U.S. Cl. CPC C11D 7/261; B24D 15/00; B24B 1/00
USPC 451/59; 510/109; 451/526

(57) ABSTRACT

A surface polishing composition is provided that includes a polyhydric alcohol, and a base present to give the composition a pH of between 9 and 12, an oil, an abrasive, and the majority component of the composition being water. The composition is particularly effective at removing water spots from a surface without resort to acid that can damage the finish on the surface or induce corrosion in the substrate beneath the surface. A polishing composition is provided in a kit form with an applicator along with instructions for the respective use of the composition and applicator to remove water spots from the surface. A clay bar is particularly well suited as an applicator. A process provided for removing water spots from a surface that includes applying to the surface the composition and then simultaneously contacting the composition with the substrate and the applicator.

### RELATED APPLICATIONS

This application is a non-provisional application that claims priority benefit of U.S. Provisional Application Ser. No. 61/681300 filed Aug. 9, 2012; the contents of which are hereby incorporated by reference.

### FIELD OF THE INVENTION

The present invention in general relates to a polishing composition and kit for application thereof to a surface, and in particular, to a non-acidic composition effective to remove water spots from glass and painted surfaces.

### BACKGROUND OF THE INVENTION

Water spots on surfaces result from the deposition of minerals from hard water droplets upon evaporation. Such spots under environmental conditions are chemically reactive and are observed to embed proximal to the surface of glass and painted substrates. In addition to detracting from the aesthetic appearance of surfaces such as those of a vehicle, embedded water spots if left untreated, can become nucleation points for substrate corrosion or structural failure. Conventional methods to address embedded water spots in glass and paint substrates have included corrosive products such as those including acids, abrasive packages or complex chemical combinations. While conventional products work to varying degrees, such products have met with limited acceptance owing surface damage, problems of metal substrate corrosion, damage to clear coat coatings, and complex usage processes. Representative of these conventional compositions are those found in U.S. Pat. No. 5,164,018.

Thus, there exists a need for a surface polishing composition able to remove water spots without resort to acids. There further exists a need for such a composition and a system for the efficient use of the composition to remove water spots from vehicle glass and/or painted surfaces.

### SUMMARY OF THE INVENTION

A surface polishing composition is provided that includes a polyhydric alcohol, an oil, an abrasive, and a base present to give the composition a pH of between 9 and 12, the majority component of the composition being water. The composition is particularly effective at removing water spots from a surface without resort to acid that can damage the finish on the surface or induce corrosion in the substrate beneath the surface. A polishing composition is provided in a kit form with an applicator along with instructions for the respective use of the composition and applicator to remove water spots from the surface. A clay bar is particularly well suited as an applicator.

A process provided for removing water spots from a surface that includes applying to the surface the composition and then simultaneously contacting the composition with the substrate and the applicator. The application of mechanical forces through the applicator to the surface are sufficient along with the chemical activity of the composition to remove the water spots from the surface without resort to acid and damage associated therewith.

### DETAILED DESCRIPTION OF THE PREFERRED EMBODIMENTS

The present invention has utility as a polishing composition for the removal of water spots from glass and painted surfaces without resort to an acidic pH composition. The present invention also has utility in the context of a surface cleaning kit in which an inventive polishing composition is used in combination with an application to facilitate removal of mineral deposits associated with the water spots. An inventive composition is readily applied to the water spotted surface for removal of the water spots. The surface illustratively including window glass, a painted surface, and mirror; and especially such surfaces associated with a vehicle exterior.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

An inventive polishing composition includes a base. Typically, a base is present from 0.1 to 5 total weight percent of the composition to yield a pH of from 9 to 12 and in a preferred range of 10 to 12. The base operative herein illustratively includes ammonium hydroxide, (C₂-C₈)ₙNH₃₋ₙ where n is 1 or 2. An inventive polishing composition also includes a polyhydric alcohol. Typically, a polyhydric alcohol is present in an inventive polishing composition from 0.1 to 10 total weight percent. In particular embodiments, the polyhydric alcohol is present from 1 to 5 total weight percent. Polyhydric alcohols operative herein illustratively include ethylene glycol, propylene glycol, polyethylene glycol, polypropylene glycol, glycerol, a mixed poly(ethylene glycol-propylene glycol), and a combination thereof. Polyhydric alcohol acts as lubricant between an applicator such as a clay bar and the surface to be treated.

An inventive polishing composition, also includes an oil which is defined herein as being a liquid at standard temperature and pressure. Typically, an oil is present in an inventive polishing composition in an amount of between 0.5 and 15 total weight percent and preferably, if present, from 4 to 8 total weight percent. Oils operative herein include oils of natural origin such as castor, palm, corn, olive, flax seed, linseed, cotton seed, and canola; and synthetic oils such as mineral, seal, and white mineral, and combinations thereof.

An inventive composition also includes an abrasive such as pumice, carborundum, sand, aluminum oxide or combinations thereof in amounts typically between 0.1 and 15 total weight percent. In specific embodiments an abrasive is present from 4 to 8 total weight percent. Abrasive particulate has a typical mean particle size of between 0.1 and 500 microns, and preferably between 1 and 20 microns. It is appreciated that a suspended abrasive tends to settle from an inventive composition. Homogeneity is readily restored by agitation prior to use. It is further appreciated that inclusion of an optional thickener promotes abrasive suspension in an inventive composition.

The remainder of the composition is water. Deionized water, distilled water, and tap water are all appreciated to be operative herein.

Without intending to be bound to a particular theory, it is believed that the base operates at pH values of between 7 and 12 to form soluble complexes of metal ions associated with water spots on a substrate, as well as to saponify organic acids and other substances associated with a water spot or substrate debris. The remaining components form a stable oil-in-water emulsion that is able to stabilize water spot components that have been lifted from the substrate by contact with an inventive polishing composition. It is noted that in several successful embodiments of the inventive polishing composition, the composition pH is between 9 and 10 and other compositions with a pH between 10 and 12.

An inventive polishing composition is effectively used to remove water spots from affected substrate with a variety of application techniques. It is appreciated that the application of manual force across the surface of the water spot and inventive composition with an applicator is particularly effective. Applicators operative herein illustratively include a natural fiber cloth, a synthetic fiber cloth, a sponge, or a clay bar.

Optionally, chelating agents for Group IIA including calcium and magnesium ions at inventive pH values of for example, (ethylenediaminetetraacetic acid) EDTA or (Nitrilotriacetic acid) NTA; ammonium sulfate; ammonium phosphate: ammonium chloride; monoethanolamine; and combinations thereof It is appreciated that carboxyl groups associated with chelating agents are often neutralized upon exposure to ammonium salts depending on composition pH, and carboxylate group pKa values. It is appreciated that carboxyl groups at pH values of greater than 8 are often ammoniated.

An inventive polishing composition optionally includes additional components such as a fragrance, an antimicrobial, a colorant, and a thickener.

Optional additives to a base inventive composition that are well suited for the formation of an inventive composition include fragrance compounds typically present from 0.001 to 3 total percent; an antimicrobial to improve storage stability that illustratively includes quaterniums, and other conventional antibacterials, an antimicrobial typically being present from 0 to 2 total weight percent and preferably between 0.005 and 1 total weight percent; a colorant present in an amount of from 0 to 1 total weight percent and preferably, from 0 to 0.3 total weight percent; and a thickener that illustratively includes fumed silica, polyacrylates, bentonite clays, and combinations thereof. A thickener is typically present from 0 to 4 total weight percent, and preferably, from 0 to 3 total weight percent. It is appreciated that an inorganic thickener also affords an added degree of abrasiveness to the inventive composition.

Typical and preferred amounts of components in an inventive polishing composition according to the present invention are provided in Table 1.

TABLE 1
Inventive polishing composition (amounts in total weight percent)

| Component | Typical Amount | Preferred Amount |
|---|---|---|
| Polyhydric Alcohol | 0.1-10 | 1-5 |
| Base | 0.1-5 | 1-3 |
| Oil | 0.5-15 | 4-8 |
| Abrasive | 0.1-15 | 4-8 |
| Water | 50-remainder | 60-remainder |
| Fragrance | 0-3 | 0.1-1.5 |
| Antimicrobial | 0-3 | 0.1-1.5 |
| Colorant | 0-3 | 0.1-1 |
| Chelating Agent | 0-5 | 1-3 |
| Thickener | 0-4 | 1-3 |

Regardless of the mechanism by which an inventive polishing composition is applied, an inventive polishing composition is brought into simultaneous contact between the surface from which water stains are to be removed and an applicator. The applicator being a cotton cloth, a microfiber cloth, or a clay bar. Upon the application of force to the applicator, the inventive polishing composition removes water stain spots without resort to a conventional polishing composition having an acidic pH that while effective in removing such water spots is the ability to damage surface finish and/or induce corrosion in metallic substrates underlying the surface. It is appreciated that an inventive polishing composition devoid of abrasive is used effectively with an applicator having a grit coated applicator surface.

An inventive polishing composition is used to remove water spots from glass and other substrates through application of mechanical forces including transverse forces parallel to the glass or other substrate surface having water spots thereon. In a particular embodiment, an inventive polishing composition is used in conjunction with a clay bar as an applicator. A clay bar having the attribute of conforming to the surface and exerting high transverse forces on spots or stains on surface through the peeling or otherwise removing the clay from contact with the subject surface.

An exemplary conventional clay composition suitable as an applicator includes a polymer matrix formed of polymers such as polyisobutylene with abrasive grit intermixed within the polymer matrix. Oils such as those detailed above, antioxidants, rubber, and pigments so included in conventional embodiments improve storage stability and resiliency, or other properties of the clay applicator. A suitable clay composition is detailed in U.S. Pat. No. 8,025,557.

An inventive polishing composition is readily provided in a kit or form along with a clay bar, sponge, or cloth applicator, along with the instructions for the use thereof to remove water stains from a surface.

The present invention is further detailed with respect to the following non-limiting example that is provided to further illustrate the preparation of inventive compositions and the operational attributes associated with removal of water spots from surfaces upon interaction with an inventive composition.

### Example 1

A polishing composition is prepared including 5 total weight percent mineral oil, 1 total weight percent polyhydric alcohol, 7 total weight percent of abrasive, 2.5 total weight percent thickener, 1.5 total weight percent base, base present to raise the pH to 10 with the remainder of the composition being water. The paste polishing composition is applied to a clay bar, rubbed back and forth over the water spot on the spotted surface to remove the deposits without etching or scratching the surface.

Patents and publications mentioned in the specification are indicative of the levels of those skilled in the art to which the invention pertains. These patents and publications are incorporated herein by reference to the same extent as if each individual patent or publication was specifically and individually incorporated herein by reference.

The foregoing description is illustrative of particular embodiments of the invention, but is not meant to be a limitation upon the practice thereof. The following claims, including all equivalents thereof are intended to define the scope of the invention.

1. A polishing composition comprising:
a polyhydric alcohol;
a base present in a quantity to provide the composition with an overall pH of between 9 and 12;
an oil;
an abrasive; and
water as a majority component of the composition.

2. The composition of claim 1 wherein the overall pH 10 and 12.

3. The composition of claim 1 further comprising at least one of a fragrance, an antimicrobial, and a colorant.

4. The composition of claim 1 further comprising a thickener.

5. The composition of claim 1 wherein said polyhydric alcohol is present from 0.1 to 10 total weight percent.

6. The composition of claim 2 wherein said oil is present from 0.5 to 10 total weight percent.

7. A kit for removing water spots from a surface comprising:
a polishing composition comprising: a polyhydric alcohol, a base present in a quantity to provide the composition with a small pH of between 9 and 12, an oil, an abrasive, and water as a majority component of the composition; and
a polishing applicator, together with instructions for applying the composition to a water spot stained substrate and applying force to the applicator and the composition against the surface.

8. The kit of claims 7 wherein said applicator is a clay bar.

9. The kit of claims 7 wherein the said applicator is a sponge or cloth.

10. A process for removing water spots from a surface comprising:
applying to the surface a polishing composition of claim 1; and
contacting simultaneously the composition with the substrate and an applicator to apply forces to the substrate sufficient to remove the water spots.

11. The process of claim 10 wherein said applicator is a clay bar and said contacting step involves pressing then peeling said clay bar from the substrate.

12. The process of claim 10 wherein the surface is vehicle glass or a painted exterior vehicle panel.
